(19) United States
(12) Patent Application Publication
(10) Pub. No.: US 2025/0136490 A1
(43) Pub. Date: May 1, 2025

(54) SYSTEM AND METHOD FOR TREATMENT OF BIOMASS CONTAINING WASTEWATER FOR RENEWABLE ENERGY

(71) Applicant: Evoqua Water Technologies LLC, Pittsburgh, PA (US)

(72) Inventors: Hari G. Gupta, Schaumburg, IL (US); James M. Ceklosky, Canonsburg, PA (US); Ivan Zhu, Sewickley, PA (US); Mark D. Hunsaker, Elk Grove Village, IL (US)

(21) Appl. No.: 18/855,368

(22) PCT Filed: Feb. 3, 2023
(86) PCT No.: PCT/US2023/012317

§ 371 Date: Oct. 9, 2024

Related U.S. Application Data
(60) Provisional application No. 63/306,556, filed on Feb. 4, 2022.

(51) Int. Cl. C02F 9/00; B01D 61/02; C02F 1/44; C02F 1/66; C02F 11/04; C02F 11/06; C02F 11/127; C02F 11/148; C02F 101/10; C02F 101/16; C02F 103/36

(52) U.S. Cl. CPC C02F 9/00; B01D 61/026; B01D 61/0271; B01D 61/029; B01D 2317/022; B01D 2317/025; C02F 1/441; C02F 1/442; C02F 1/66; C02F 11/04; C02F 11/06; C02F 11/127; C02F 11/148; C02F 2101/101; C02F 2101/16; C02F 2103/36; C02F 2209/06; C02F 2301/08; C02F 2303/10; C02F 2303/22

(57) ABSTRACT

A method of treating biomass and ammonia-containing wastewater comprises anaerobically digesting the wastewater to produce a digestate, oxidizing dissolved sulfides in the digestate, mixing the digestate to form a mixed liquid, filtering the mixed liquid to produce a first filtrate, removing ammonia from the first filtrate to produce an ammonia-depleted filtrate, removing organic contaminants and divalent ions from the ammonia-depleted filtrate by nanofiltration to produce an organic-containing second retentate and an organic-depleted second filtrate, removing additional organic contaminants from the organic-containing second retentate by a second nanofiltration operation to produce a third filtrate and a third retentate, removing inorganic ionic species from the organic-depleted second filtrate by reverse osmosis to produce a fourth filtrate and a fourth retentate, combining the third filtrate and the fourth retentate, and removing additional inorganic ionic species from the combined third filtrate and fourth retentate by a second reverse osmosis operation.

### FIELD OF TECHNOLOGY

Aspects and embodiments disclosed herein are generally related to treatment of wastewater containing flushed biomass, and more specifically, to recovery of water during treatment of wastewater containing stillage produced during the production of ethanol.

### SUMMARY

In accordance with one aspect, there is provided a method of treating biomass and ammonia-containing wastewater. The method comprises anaerobically digesting the biomass and ammonia-containing wastewater to produce a biogas and a digestate, oxidizing dissolved sulfides in the digestate, mixing the digestate to form a mixed liquid, filtering a portion of the mixed liquid to produce a first filtrate and a first retentate, removing ammonia from the first filtrate to produce an ammonia-depleted filtrate, removing organic contaminants and divalent ions from the ammonia-depleted filtrate by nanofiltration to produce an organic-containing second retentate comprising divalent ions and an organic-depleted second filtrate, removing additional organic contaminants from the organic-containing second retentate by a second nanofiltration operation to produce a third filtrate and a third retentate, removing inorganic ionic species from the organic-depleted second filtrate by reverse osmosis to produce a fourth filtrate and a fourth retentate, combining the third filtrate and the fourth retentate, and removing additional inorganic ionic species from the combined third filtrate and fourth retentate by a second reverse osmosis operation to form a product water.

In some embodiments, the method further comprises performing solids-liquid separation of a second portion of the mixed liquid and returning the liquid obtained to a vessel for oxidizing the dissolved sulfides.

In some embodiments, the method further comprises controlling pH of the ammonia-depleted filtrate to be between about 7-9 and dosing the ammonia-depleted filtrate with an antiscalant.

In some embodiments, the method further comprises processing the biogas to produce natural gas.

In some embodiments, the method further comprises using energy generated by the biogas to power at least one operation of the method.

In some embodiments, the method further comprises adjusting a pH of the biomass and ammonia-containing wastewater to about 6 or above prior to anaerobically digesting the biomass and ammonia-containing wastewater.

In accordance with another aspect, there is provided a system for treating biomass and ammonia-containing wastewater. The system comprises an anaerobic digester having an inlet fluidly connectable to a source of the biomass-containing wastewater, a biogas outlet, and a digestate outlet, an oxidation tank having an inlet fluidly connected to the digestate outlet, and an oxidation tank outlet, a source of softening agent configured to deliver the softening agent into a mixing vessel having an inlet fluidly connected to the oxidation tank outlet, and a mixing vessel outlet, a concentration tank having an inlet fluidly connected to the mixing vessel outlet, and first and second mixed liquid outlets, a solids-liquid separator having an inlet fluidly connected to the first mixed liquid outlet of the concentration tank, and a separated liquids outlet fluidly connected to the inlet of the oxidation tank, a membrane filtration unit having an inlet fluidly connected to the second mixed liquid outlet of the concentration tank, a filtrate outlet, and a retentate outlet, an ammonia-reducing column having an inlet fluidly connected to the filtrate outlet, a countercurrent source of an acid, and an ammonia-depleted filtrate outlet, a first nanofiltration unit having an inlet fluidly connected to the ammonia-depleted filtrate outlet, a filtrate outlet, and a retentate outlet, a second nanofiltration unit having an inlet fluidly connected to the retentate outlet of the first nanofiltration unit, and a filtrate outlet, a first reverse osmosis unit having an inlet fluidly connected to the filtrate outlet of the first nanofiltration unit, a filtrate outlet, and a retentate outlet, and a second reverse osmosis unit having an inlet fluidly connected to the filtrate outlet of the second nanofiltration unit and the retentate outlet of the first reverse osmosis unit.

In some embodiments, the solids-liquid separator comprises a centrifuge.

In some embodiments, the system further comprises at least one of a source of a coagulant and a source of a flocculant positioned upstream from the centrifuge.

In some embodiments, the system further comprises a first source of a pH adjuster positioned upstream from the ammonia-reducing column.

In some embodiments, the system further comprises a second source of a pH adjuster positioned upstream from the first nanofiltration unit and/or a source of an antiscalant positioned upstream from the first nanofiltration unit.

In some embodiments, the system further comprises the anaerobic digester is a continuous stirred tank reactor (CSTR).

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a box diagram of a system for treatment of biomass-containing wastewater, according to one embodiment;

FIG. 2 is a box diagram of a portion of a system for treatment of biomass-containing wastewater, according to one embodiment;

FIG. 3A is a box diagram of a portion of a system for treatment of biomass-containing wastewater, according to one embodiment;

FIG. 3B is a box diagram of a portion of a system for treatment of biomass-containing wastewater, according to one embodiment; and

FIG. 4 is a box diagram of a system for treatment of biomass-containing wastewater, according to one embodiment.

### DETAILED DESCRIPTION

In one aspect, the disclosure relates to a system and method which can be employed to reduce odors and recover biogas and water from flushed biomass such as stillage and, more specifically, to a closed system apparatus that provides for the anaerobic digestion of flushed biomass and the minimization of freshwater consumption. The system and method disclosed herein may generally relate to anaerobic digestion of biomass, such as flushed stillage from an ethanol production plant, and reducing or minimizing fresh water consumption. In particular, the amount of fresh water used by the disclosed system and method may be reduced or minimized by recovering and recycling wastewater from the process. The disclosure relates to systems and methods for recovering and recycling the wastewater. Wastewater treated by the systems and methods disclosed herein may be free of animal waste.

The systems and methods disclosed herein relate to treatment of organic material under anaerobic conditions. Anaerobic digestion of biomass has been implemented for many years. In anaerobic digestion, a mixed culture of bacteria mediates the degradation of the putrescible fraction of organic matter ultimately to methane, carbon dioxide, and mineralized nutrients. Upon storage, biomass begins this process of degradation resulting in the production of intermediate compounds, which are volatile and often a source of odors. Since methanogenic microorganisms grow slowly and are present in limited numbers in fresh biomass, these volatile intermediates accumulate in stored biomass. In an effective anaerobic digester, the growth of methanogens is promoted such that the intermediate compounds are converted to biogas and nutrients, and the odor potential of the biomass is greatly reduced. Additionally, biogas is recovered and converted to heat energy which can be used as heat for various process in the facility or the biogas can be converted to electrical energy with an internal combustion engine.

The principal means for promoting methanogenic growth in anaerobic digestion of biomass are controlling the operating temperature and/or controlling the residence time of the bacteria within the process. The types of anaerobic digester that have been implemented in the digestion of biomass are rather limited due to the nature of biomass as a substrate. The digester types have included variations of batch and semi-continuous processes, which include plug-flow digesters, complete-mix digesters, covered lagoons, and continuously stirred reactors.

During anaerobic treatment, an organic material slurry may be directed to a tank or reactor comprising anaerobic microorganisms. The anaerobic microorganisms convert biologically degradable material in the wastewater primarily into water, biogas, and biosolids. In particular, anaerobic microorganisms facilitate decomposition of macromolecular organic matter into simpler compounds and biogas by methane fermentation. Exemplary anaerobic microorganisms include methanogens and acetogens. The produced biogas is primarily carbon dioxide and methane but may include other constituents depending on the composition of the slurry.

Anaerobic treatment may generally refer to situations in which the prevailing conditions of the slurry within the tank or reactor are anaerobic. The tank or reactor may be closed. The tank or reactor may be open. In particular, even in embodiments in which the anaerobic treatment tank or reactor is open, anaerobic treatment may occur in the absence of added oxygen when the prevailing conditions in the water are anaerobic.

Microorganism growth may be promoted by addition of microorganisms during start-up and/or dosing with microorganism nutrients. The odor potential of the organic material may be greatly reduced. Methanogenic growth in anaerobic digestion of organic material may be controlled by controlling operating temperature, residence time of the bacteria within the digestor, and/or mixing conditions.

Additionally, the produced biogas may be recovered and converted to heat energy. The heat energy may be used as heat for various processes in the facility. The biogas may be converted to electrical energy with an internal combustion engine.

In additional to biogas recovery, one important factor is the minimization of water consumption. The process of treating biomass consumes vast quantities of water. However, it is possible to treat the wastewater and recover a large percentage of the water so that the amount of fresh water required is minimized. The systems and methods disclosed herein may be utilized to treat the process wastewater and recover a percentage of the water to reduce or minimize the amount of fresh water required. Anaerobic digestion of wastewater containing biomass may be a batch or semi-continuous processes. For instance, anaerobic digestion may be performed in plug-flow digesters, complete-mix digesters, covered lagoons, or continuously stirred reactors.

Thus, in accordance with one aspect, there are provided systems and methods for treating wastewater including flushed biomass. The biomass may comprise organic stillage. The stillage may be a waste product of ethanol production.

The wastewater to be treated may be high in suspended and dissolved solids and have a high oxygen demand. For example, the wastewater may have above 4,000 mg/L total suspended solids (TSS), from 3,000-4,000 mg/L volatile suspended solids (VSS), from 4,000-5,000 mg/L total dissolved solids (TDS), have 35,000 mg/L or greater biochemical oxygen demand (BOD), 55,000 mg/L or greater soluble chemical oxygen demand (sCOD), and 60,000 mg/L or greater total chemical oxygen demand (COD).

The method may comprise introducing the wastewater into a holding tank and adjusting the pH of the wastewater in the holding tank by addition of an acid or base as needed to bring the pH of the wastewater to a pH conducive for anaerobic digestion, for example, a pH of between 6 and 8.

From the storage tank the pH adjusted wastewater (or non-pH adjusted wastewater if pH adjustment was not deemed necessary) is introduced through a feed pump and a coarse screen (for example, a ¼ inch mesh strainer) into an anaerobic bioreactor. In some embodiments, the anaerobic bioreactor may be a BVF® reactor from Evoqua Water Technologies, LLC. The organic material in the wastewater is digested in the anaerobic bioreactor, producing biogas, sludge, and an anaerobically treated effluent having a lower oxygen demand than the wastewater introduced into the anaerobic bioreactor. The anaerobically treated effluent may also have a reduced nitrogen content as compared to the wastewater introduced into the anaerobic bioreactor. A portion of the sludge is recycled back to an inlet of the anaerobic bioreactor via a recycle pump to provide better contact between the sludge and incoming wastewater, and provide buffering of pH, alkalinity, organic loading, and temperature. In some embodiments, a majority of the sludge, for example, a volume of sludge equal to between 50% and 100% of the volume of incoming wastewater may be recycled to the inlet of the anaerobic bioreactor. Excess sludge may be disposed of or utilized as agricultural fertilizer. The biogas is captured and may be used for fuel or may be released to the environment. For example, the biogas may be measured/collected/discharged via a biogas metering system, and then vented to outdoor atmosphere. Biogas samples may be collected and used to measure the biogas composition (CH₄, CO₂, H₂S, and O₂).

The anaerobically treated effluent is directed into an oxidation vessel for oxidizing dissolved sulfides in the anaerobically treated effluent. An oxygen-containing gas, for example, air is supplied to an aeration diffuser in the oxidation vessel using an air pump.

Effluent from the oxidation vessel is directed into a mixing tank for softening, for example, by the addition of lime and/or caustic. A coagulant, for example, ferric chloride and/or a flocculant, for example, a polymer may also be mixed into the oxidation vessel effluent in the mixing tank.

After softening and coagulation, the partially treated wastewater is fed into a concentration tank where it is mixed to form a mixed fluid. A portion of the mixed fluid from the concentration tank is withdrawn and processed through a solids/liquid separation unit, for example, a centrifuge. The low-solids separated liquid or centrate from the solids/liquid separation unit may be sent back to the oxidation vessel. The high solids portion from the solids/liquid separation unit may be disposed of.

The remainder of the mixed fluid from the concentration tank is directed into a cross-flow filtration system, for example, a cross-flow microfiltration system, for removal of additional solids. The cross-flow filtration system may be, for example, a MemTek® microfiltration system from Evoqua Water Technologies, LLC. The Evoqua MemTek® microfiltration system is a standalone, PLC controlled unit with a VFD-controlled feed pump and a concentration tank. The membrane is made of PVDF with a nominal pore size of 0.1 um. The membrane modules are of tubular type with cross-flow design. During the operation, the total suspended solids can be concentrated 3 to 5%. The high solids concentrated fluid produced in the cross-flow filtration system may be bled out periodically to a sludge holding tank and subsequently fed into a centrifuge for solids-liquid separation. The solids will be disposed of and centrate recycled to the front of the oxidation tank.

Filtrate from the cross-flow filtration system is processed through a gas separation apparatus, for example, a Liqui-Cell™ gas separation membrane apparatus from the 3M Company to remove ammonia. Sulfuric acid may be added to the gas separation apparatus to react with ammonia in the filtrate to form and precipitate ammonium sulfate, which is removed and disposed of.

After ammonia stripping the filtrate is directed through a water recovery sub-system. Water recovery in the water recovery sub-system may involve passing the filtrate from the ammonia stripping operation through a first nanofiltration (NF) unit and brackish water reverse osmosis (BWRO) unit, in a batch model. In some embodiments, an antiscalant and/or an acid (for example, sulfuric acid) or base for pH adjustment may be added to the filtrate prior to entering the first NF unit and/or to the permeate of the first NF unit prior to entering the BWRO unit.

The reject or retentate from the first NF unit will be further processed through a second NF unit. The second NF unit is a loose pore NF membrane unit designed for the removal of organic compounds. This step may be referred to as nanofiltration reject recovery (NFRR).

After NFRR, the permeate of the second NF unit will be combined with BWRO reject and fed through a sea water RO (SWRO) skid, optionally after the addition of further antiscalant. The SWRO permeate will be combined with BWRO permeate as the final treated product water which may be used for, for example, yeast production and/or rich scrubber supplement. Reject from the second NF unit used in the NFRR step will be combined with SWRO reject and be disposed of, for example, to the sewer or an evaporation pond.

In some embodiments, the NF/RO skid is a microprocessor-controlled unit, which can be fitted with multiple NF or RO modules. The skid includes a VFD-controlled pump, flow indicators, temperature indicator, and pressure gauges. Different membranes will be used for the nanofiltration and RO steps.

The systems and methods disclosed herein may include anaerobically digesting the biomass-containing wastewater to produce a biogas and a digestate. Anaerobic digestion includes bringing the organic material slurry into contact with a microorganism population in a substantially anaerobic environment. The anaerobic microorganism population may break down organic matter from the wastewater and produce biogas. During anaerobic digestion, organic nitrogen may be converted to ammonia. Temperature of the anaerobic digestion may be controlled. In some embodiments, temperature of the anaerobic digestion may be between, for example, 90-100° F. (32-38° C.) or 95-100° F. (35-38° C.). The anaerobic microorganism mixed liquor within the digester may be agitated, for example, in a continuous stirred tank reactor.

Nutrients and/or alkalinity agents may be supplied to the anaerobic microorganisms, for example, nitrogen, phosphorous, sodium bicarbonate, urea, phosphoric acid, and combinations thereof. Total Kjeldahl Nitrogen (TKN) and ammonia nitrogen (NH₃—N) measurements of the digestate may be used to determine whether sufficient nitrogen is available for the digestion process. Phosphate phosphorous (PO₄—P) measurements of the digestate may be used to determine whether sufficient phosphorous is available for the digestion process. Thus, the methods may comprise measuring nitrogen content and/or phosphorous content of the digestate. The methods may comprise supplying an effective amount of nutrients and/or alkalinity agents responsive to the digestate measurement.

Residence time of the mixed liquor within the anaerobic digester may be controlled. The wastewater may be in contact with the microorganism population for an amount of time sufficient to convert a predetermined amount of biomass into biogas. In some embodiments, the wastewater may be in contact with the microorganism population for an amount of time sufficient to exhaust biogas production from the wastewater. The hydraulic retention time (HRT) of the mixed liquor in anaerobic digestion may be 15-35 days, for example, 20-30 days, about 15 days, about 20 days, about 25 days, about 30 days, or about 35 days.

The method may comprise collecting the raw biogas produced by the digestion. The raw biogas may comprise methane and carbon dioxide. The raw biogas may comprise water vapor. The raw biogas may comprise additional constituents or nutrients based on the composition of the wastewater. In some embodiments, the raw biogas may be at least 40% methane, at least 45% methane, at least 50% methane, at least 55% methane, at least 60% methane, or at least 65% methane. Carbon dioxide may make up a majority of the remainder of the biogas.

The method may comprise measuring flow volume of the raw biogas. The method may comprise measuring composition of the raw biogas produced by the digestion. The composition of the raw biogas may depend on the composition of the wastewater. For example, the composition of the raw biogas may depend on carbon to nitrogen ratio (C:N), pH, moisture, total solids, temperature, biological oxygen demand (BOD), loading rate, and HRT of the wastewater.

The methods may comprise measuring methane content of the raw biogas. The methods may comprise controlling one or more parameter of the digestion responsive to the methane measurement, for example, controlling temperature, mixing conditions, loading rate, or HRT of the digestion responsive to the methane concentration being below a predetermined threshold, for example, below 55%, below 50%, below 45%, or below 40%.

Certain parameters may be controlled to increase methane content of the raw biogas. In exemplary embodiments, pH of the wastewater may be controlled to be about 6-8. Temperature may be controlled to be 90-100° F. (32-38° C.), for example, 95-100° F. (35-38° C.). Mixing conditions of the mixed liquor within the digester may be controlled.

The systems and methods disclosed herein may use energy generated by the biogas. In some embodiments, energy may be generated by the biogas in the form of heat energy. Heat energy may be captured from the biogas with a boiler or combined heat and power process. The captured heat energy may be used by one or more unit operations of the system. The captured heat energy may be used by a unit operation of the facility. Heat energy may be converted with a heat exchanger loop. For example, heat energy may be transferred to an energy demand with a heat exchanger loop. The energy demand may include one or more unit operations of the system and/or another unit operation of the facility.

In some embodiments, energy may be generated by the biogas in the form of electrical energy. Energy from the biogas may be converted to electrical energy with an internal combustion engine. The electrical energy may be used to operate one or more unit operations of the system and/or another unit operation of the facility.

In some embodiments, the method may comprise processing the raw biogas to produce natural gas. The raw biogas may be refined and converted to natural gas, for example, renewable natural gas (RNG). The refinement process may include removing moisture, carbon dioxide, and trace level contaminants from the raw biogas including, for example, any siloxanes, volatile organic compounds (VOCs), and hydrogen sulfide. The refinement process may include removing nitrogen and oxygen content of the raw biogas. The refinement process may produce a natural gas having a methane content of at least 90%. In some embodiments, the produced natural gas may have a methane content of at least 92%, at least 94%, at least 96%, or at least 98%. The produced natural gas may be injected into a conventional natural gas pipeline or used to replace fossil fuel natural gas in any existing application. For example, the produced natural gas may be used to generate electrical energy. The electrical energy may be used by one or more unit operations of the system and/or a unit operation of the facility.

The digestate produced by the anaerobic digestion may be a sludge-containing wastewater. The digestate may comprise 1,500-3,000 ppm total suspended solids (TSS). The digestate may comprise 3,500-6,000 ppm TDS. The digestate may comprise 50-150 ppm calcium. The digestate may comprise 200-300 ppm magnesium.

The method may comprise separating the digestate to produce a digestate solids and a filtrate. The digestate solids may retain substantially all of the suspended solids from the digestate and a portion of the dissolved solids. Thus, the separation may reduce TSS of the stream by at least 95%, at least 98%, at least 99%, at least 99.9%, or at least 99.99%. The separation may reduce TDS of the stream by about 30%-65%, for example, about 35%, about 50%, or about 65%. The separation may be performed by one or more of centrifuge separation, thickening, straining, settling, and membrane filtration. The digestate solids may be collected to produce a solids product. The filtrate may be further treated to produce product water, as described below.

The separation of the digestate into digestate solids and a filtrate may comprise dosing the digestate with at least one of a coagulant and a flocculant to produce a digestate sludge. A coagulant may induce coagulation of suspended solids in the digestate. Coagulation may be induced by destabilization of colloidal and dispersed particles, inducing growth to larger particle sizes. Exemplary coagulants include anionic and cationic molecules. A flocculant may induce flocculation of suspended solids in the digestate. Flocculation may be induced by agglomerating solids, such as coagulated solids and other suspended solids, into aggregates or complexes. Exemplary flocculants include high molecular weight polymers having exposed bonding groups to aggregate suspended and coagulated solids. Certain separation additives may act as both coagulants and flocculants. Exemplary separation additives include calcium hydroxide (lime), ferric sulfate, anionic polymers, and cationic polymers. One exemplary separation additive is Alumafloc™ separation additive. Thus, the separation may comprise dosing the digestate with one or more of calcium hydroxide, ferric sulfate, an anionic polymer, and a cationic polymer. The digestate sludge comprising the agglomerated solids may be collected to produce the solids product.

In some embodiments, the separation of the digestate into digestate solids and a filtrate may be performed by a series of separations. For example, the separation may comprise dosing the digestate with at least one of a coagulant and a flocculant to produce the digestate sludge comprising large suspended solids. The digestate sludge may be separated from the digestate by at least one centrifuge and/or settling. Settling may separate the digestate into the digestate sludge and a supernatant. Additional water may be removed from the settled digestate sludge in a centrifuge. In some embodiments, the separation may comprise thickening the digestate prior to separation by the centrifugation and/or settling. Remaining suspended solids in the digestate or the supernatant from the settling operation may then be separated by a filtration membrane, for example, by cross-flow filtration, to produce a retentate and a filtrate.

In exemplary embodiments, the digestate may be dosed with calcium hydroxide. Calcium hydroxide may induce agglomeration of suspended solids as a coagulant. Calcium hydroxide may also reduce calcium and magnesium concentration of the solution, as a softener. For instance, the methods may comprise dosing the digestate with an amount of calcium hydroxide effective to produce a filtrate with at least 90% less calcium and magnesium than the digestate. Additionally, calcium hydroxide may increase the pH of the solution. The pH may be controlled for removal of ammonia, as described below.

The methods may comprise returning the one or more dosing agent, for example, coagulant, flocculant, or calcium hydroxide, to an upstream reaction tank. The methods may comprise returning sludge, for example, activated sludge, to the anaerobic digester or an upstream reaction tank.

The methods may comprise controlling pH of the filtrate from the cross-flow filtration unit to less than about 10. For example, the methods may comprise controlling pH of the filtrate to be between about 4 and about 10, between about 7 and about 10, or between about 9 and about 10. The methods may comprise dosing the filtrate with an effective amount of a pH adjuster. The pH adjuster may comprise an acid or a base. Exemplary pH adjusters include strong bases, for example, sulfuric acid, hydrochloric acid, perchloric acid, and nitric acid. Other exemplary pH adjusters include, for example, potassium hydroxide, sodium hydroxide, sodium carbonate, ammonium hydroxide, calcium hydroxide, or magnesium hydroxide. In exemplary embodiments, pH may be controlled to be less than about 10 by dosing the filtrate with an effective amount of sulfuric acid.

The systems and methods disclosed herein may include removal of ammonia from the filtrate to produce an ammonia-depleted filtrate. During anaerobic digestion, temperature and pH of the mixed liquor are generally maintained to favor digestion of organic material into methane gas. Under such conditions, ammonia exists substantially in the ammonium-ion form. After digestion, pH may be controlled to a value effective for removal of ammonia. For example, pH may be controlled to be greater than 9 by addition of an effective amount of one or more pH adjusters. Certain separation additives, for example, coagulants and flocculants, may increase pH of the solution. In such embodiments, pH may be reduced to be below 10 with an acidic pH adjuster. Exemplary pH adjusters are calcium hydroxide and sulfuric acid, as previously described. In one exemplary embodiment, ammonia may be removed by contacting the filtrate with an ammonia reducing column running countercurrent sulfuric acid.

The methods may comprise reducing the concentration of ammonia in the filtrate to produce the ammonia-depleted filtrate. In some embodiments, the methods may comprise reducing the concentration of ammonia in the filtrate by at least about 90% to produce the ammonia-depleted filtrate. The ammonia-depleted filtrate may comprise less than 100 ppm ammonia, for example, less than 50 ppm ammonia, less than 10 ppm ammonia, less than 5 ppm ammonia, less than 2 ppm ammonia, or less than 1 ppm ammonia. The ammonia-depleted filtrate may have 100-400 ppm TDS.

The methods may comprise controlling pH of the ammonia-depleted filtrate to less than about 9, for example, between about 4-9 or 7-9. The pH of the ammonia-depleted filtrate may be controlled by dosing the ammonia-depleted filtrate with an effective amount of a pH adjuster, as previously described.

The methods may comprise dosing the ammonia-depleted filtrate with an antiscalant. The antiscalant may be a silica, sulfate (for example, barium sulfate, calcium sulfate, strontium sulfate), calcium carbonate, and/or calcium fluoride scale inhibitor. Thus, the ammonia-depleted filtrate may be dosed with an effective amount of the antiscalant to inhibit formation of scale on one or more downstream unit operations, for example, a microfiltration unit, a nanofiltration unit, and/or a reverse osmosis unit. In exemplary embodiments, the antiscalant may comprise Vitec® 7400 antiscalant (distributed by Avista Technologies, Inc., San Marcos, CA).

The methods may comprise dosing the ammonia-depleted filtrate with potassium bisulfite. Potassium bisulfite may be used to neutralize chlorine, chloramines, and residual ammonia in the ammonia-depleted filtrate.

The systems and methods disclosed herein may involve removing organic contaminants and divalent ions from the ammonia-depleted filtrate to produce an organic-containing reject and an organic-depleted filtrate. The organic contaminants and divalent ions may be removed by nanofiltration.

The organic depleted filtrate may have 40-60% less TDS than the ammonia-depleted filtrate, for example, 40-50% less TDS. The organic-depleted filtrate may have 2,000-5,000 ppm TDS, for example, 3,500-4,500 ppm TDS. The organic-depleted filtrate may have less calcium and magnesium than the ammonia-depleted filtrate. In some embodiments, the organic-depleted filtrate may have, for example, at least 90% less calcium and magnesium than the ammonia-depleted filtrate. The organic-depleted filtrate may have 10 ppm calcium or less, for example, 5 ppm calcium or less, or 1 ppm calcium or less. The organic-depleted filtrate may have 10 ppm magnesium or less, for example, 5 ppm magnesium or less, or 1 ppm magnesium or less.

The methods may comprise controlling pH of the organic-depleted filtrate to less than about 8, for example, between about 4-8 or 6-8. The pH of the organic-depleted filtrate may be controlled by dosing the organic-depleted filtrate with an effective amount of a pH adjuster, as previously described.

The method may comprise dosing the organic-depleted filtrate with an antiscalant. The organic-depleted filtrate may be dosed with an effective amount of the antiscalant to inhibit formation of scale on one or more downstream unit operations, for example, a cross-flow filtration unit, a microfiltration unit, a nanofiltration unit, and/or a reverse osmosis unit.

The systems and methods disclosed herein may involve concentrating the organic-depleted filtrate to produce a concentrated retentate and a permeate. The organic-depleted filtrate may be concentrated by reverse osmosis. The organic-depleted filtrate may be concentrated by brackish water reverse osmosis. The methods may comprise concentrating the organic-depleted filtrate between 2×-5×, for example, about 2×, about 3×, about 4×, or about 5×, to produce the concentrated retentate.

The permeate may have less TDS than the organic-depleted filtrate. In some embodiments, the permeate may have, for example, at least 90% less TDS than the organic-depleted filtrate. The permeate may have 10-500 ppm TDS, for example, 100-400 ppm TDS, or 200-300 ppm TDS.

In some embodiments, to further recover water, organic contaminants and divalent ions may be separated from the organic containing reject to produce a second organic-depleted filtrate. The organic containing reject may be separated by a second nanofiltration operation.

The method may comprise dosing the organic containing reject with an antiscalant before the separation. The organic containing reject may be dosed with an effective amount of the antiscalant to inhibit formation of scale on one or more downstream unit operations, for example, a microfiltration unit, a nanofiltration unit, and/or a reverse osmosis unit.

The method may comprise combining the second organic-depleted filtrate with the concentrated retentate to produce a dilute retentate. The method may comprise dosing the dilute retentate with an antiscalant. The dilute retentate may be dosed with an effective amount of the antiscalant to inhibit formation of scale on one or more downstream unit operations, for example, a microfiltration unit, a nanofiltration unit, and/or a reverse osmosis unit.

The method may comprise concentrating the dilute retentate to produce a second concentrated retentate and a second permeate. The dilute retentate may be concentrated by reverse osmosis. The dilute retentate may be concentrated by seawater reverse osmosis. The dilute retentate may be concentrated by brine recovery reverse osmosis. The methods may comprise concentrating the dilute retentate between 2×-5×, for example, about 2×, about 3×, about 4×, or about 5×, to produce the second concentrated retentate.

The second permeate may have less TDS than the dilute retentate. In some embodiments, the second permeate may have, for example, at least 90% less TDS than the dilute retentate. The second permeate may have 500-1,000 ppm TDS, for example, 600-900 ppm TDS, or 700-900 ppm TDS.

The method may comprise combining the second permeate with the permeate. The permeates may be combined in amounts effective to have 200-500 ppm TDS. For example, the combined permeates may have 1:5-5:1 permeate to second permeate, for example, 2:1-5:1, 3:1-4:1, or 3:1-5:1 permeate to second permeate.

In some embodiments, recovered water may be used to clean in place or backwash at least one cross-flow filtration unit, nanofiltration unit, or reverse osmosis unit of the system. For example, permeate and/or second permeate (for example, combined permeates) may be directed to backwash at least one of a cross-flow filtration unit, a nanofiltration unit, or a reverse osmosis unit of the system. The permeate may be combined with a cleaning agent to form a cleaning fluid. The cleaning agent may comprise, for example, one or more of potassium hydroxide, sulfuric acid, and hydrochloric acid. Clean in place waste may be collected to form the solids product. The clean in place waste, concentrated retentate or second concentrated retentate, organics containing reject or second organics containing reject, and digestate solids may be combined (with any digestate sludge) to form the solids product.

The systems and methods disclosed herein may produce a solids product from biomass-containing wastewater. In some embodiments, the solids product may be treated. For example, the solids product may be dried. Residual moisture may be captured from the drier and returned to the digestion or water recovery processes. The solids product may be used to produce a class A biosolids product. Solids products produced by the disclosed methods may comply with requirements for class A biosolids as established by the United States Environmental Protection Agency (EPA). The solids product may be used as a fertilizer product. The solids product may be supplemented with nutrients and/or fertilizer agents. The solids product may be used as an organic product, for example, a certified product suitable for organic farming. Fertilizer products produced by the disclosed methods may comply with requirements outlined by the Organic Materials Review Institute (OMRI).

In certain embodiments, the dosing agents disclosed herein, for example, coagulant, flocculant, softener, pH adjuster, antiscalant, and cleaning agent, may be acceptable to produce a class A biosolids product. Solids products containing dosing agents produced by the disclosed methods may comply with requirements for class A biosolids as established by the EPA. The dosing agents may be acceptable to produce an organic product, for example, a certified product suitable for organic farming. Fertilizer products containing dosing agents produced by the disclosed methods may comply with requirements outlined by the OMRI.

Thus, in accordance with another aspect, there is provided a system for treating wastewater comprising biomass. The system may include an organic material digestion subsystem and a water recovery subsystem. The organic material digestion subsystem may be configured to effectively digest the biomass and produce biogas, digestate solids, and digestate liquids. The water recovery subsystem may be configured to treat the digestate liquids and recover a substantial amount of water from the digestate liquids. A portion of the recovered water may be directed back to the biomass digestion subsystem, reducing the requirement of fresh water for the digestion.

The biomass digestion subsystem may comprise an anaerobic digester having an inlet fluidly connected to a source of biomass-containing wastewater, a biogas outlet, and a digestate outlet. The anaerobic digester may be an enclosed vessel or semi-enclosed vessel housing activated sludge comprising anaerobic microorganisms. The anaerobic digester may comprise a temperature control unit including, for example, a temperature sensor and a heater and/or chiller. The temperature control unit may be configured to control temperature of the mixed liquor within the anaerobic digester. The anaerobic digester may comprise an element for agitating the mixed liquor within the digester. In some embodiments, the anaerobic digester may be a continuous stirred tank reactor (CSTR).

The system may comprise a biogas processing unit fluidly connected to the biogas outlet. The biogas processing unit may include an energy harvesting unit. The energy harvesting unit may include a boiler or combined heat and power process. A heat exchanger and/or heat pump may be used to transfer thermal energy from the energy harvesting unit to an energy demand. In some embodiments, the heat exchanger and/or heat pump can be located onsite. Distance may be minimized between the biogas outlet of the anaerobic digester and the boiler or combined heat and power process to capture as much heat energy as possible. The energy demand may be an onsite energy demand, such as a unit operation of the system, a unit operation of the facility, and/or an ambient heating system of the facility.

The energy harvesting unit may include a combustion engine configured to generate electrical energy. The combustion engine may be located onsite. The combustion engine may be configured to use the biogas or natural gas produced from the biogas as fuel. The combustion engine may be electrically connected to an energy demand, for example, an onsite energy demand. The energy demand may be an off-site energy demand. For example, electrical energy may be generated onsite to serve an off-site energy demand. In some embodiments, the combustion engine may be located off-site.

The biogas processing unit may include a biogas treatment unit. The biogas treatment unit may be configured to refine and convert the biogas to natural gas, as previously described. In some embodiments, the biogas treatment unit may be onsite. In other embodiments, the biogas treatment unit may be remotely located.

The biomass digestion subsystem may comprise a first solids-liquid separation subsystem having an inlet fluidly connected to the digestate outlet, at least one digestate solids outlet, and a low-solids liquid outlet. The first solids-liquid separation subsystem may be configured to produce the digestate solids and the low-solids liquid. The first solids-liquid separation subsystem may comprise one or more of a centrifuge, a clarifier, and a membrane filter. The first solids-liquid separation subsystem may be configured to process about 1,000 gallons per minute of digestate. In certain embodiments, the first solids-liquid separation subsystem may be configured to direct 70-80% of the processed digestate (for example, 700-800 gallons per minute of low-solids liquid) to the water recovery subsystem. The first solids-liquid separation subsystem may be configured to direct 20-30% of the processed digestate (for example, 200-300 gallons per minute of digestate solids) to a solids holding tank.

In some embodiments, the first solids-liquid separation subsystem may comprise a concentration tank having a first outlet and a second outlet. The first solids-liquid separation subsystem may further include a centrifuge having an inlet fluidly connected to the first outlet of the concentration tank, a digestate solids outlet, and a digestate liquids outlet. The centrifuge may be configured to separate suspended solids to the digestate solids outlet and the remaining stream to the digestate liquids outlet. The biomass digestion subsystem may comprise a source of a separation additive. For example, the biomass digestion subsystem may comprise at least one of a source of a coagulant and a source of a flocculant positioned upstream from the concentration tank and/or centrifuge.

In one exemplary embodiment, the first solids-liquid separation subsystem may comprise a source of calcium hydroxide positioned upstream from a concentration tank and/or centrifuge. The first solids-liquid separation subsystem may comprise a source of an anionic polymer also positioned upstream from the concentration tank and/or centrifuge. The first solids-liquid separation subsystem may comprise a source of ferric sulfate positioned upstream from the concentration tank. The first solids-liquid separation subsystem may comprise a source of a cationic polymer positioned upstream from the concentration tank. The concentration tank may be configured to mix the digestate and any additives, for example, the calcium hydroxide, anionic polymer, cationic polymer, and/or ferric sulfate to produce a mixed liquid.

The system may comprise a solids product holding tank fluidly connected to the digestate solids outlet of the first solids-liquid separation subsystem. In some embodiments, the system may comprise a solids return configured to direct separated solids to an upstream reaction tank, for example, to the anaerobic digester or any other upstream reaction tank. The system may comprise a dosing agent holding tank. The dosing agent holding tank may be configured to capture dosing agents, for example, coagulant, flocculant, pH adjusters, or others for reuse. The dosing agent holding tank may be fluidly connected to an upstream reactor.

The water recovery subsystem may comprise a cross-flow filtration unit, for example a cross-flow microfiltration unit. The cross-flow filtration unit may have an inlet fluidly connected to an outlet of the concentration tank, a retentate outlet, and a filtrate outlet. The cross-flow filtration unit may be a membrane filter, a hollow fiber membrane filter, a plate and frame membrane filter, a spiral membrane, a dead end filter, a cross-flow filter, or any other type of filter having pores dimensioned to perform microfiltration. The average pore size of the cross-flow filtration membrane may be, for example, from 0.02 μm to 0.1 μm. The cross-flow filtration unit may be configured to separate mixed liquid from the concentration tank into the retentate and the filtrate. The cross-flow filtration unit may be configured to process 700-800 gallons per minute of fluid.

The water recovery subsystem may comprise an ammonia-reducing column having an inlet fluidly connected to the filtrate outlet, a countercurrent source of an acid, and an ammonia-depleted filtrate outlet. The ammonia-reducing column may be configured to strip ammonia from the filtrate and produce an ammonia-depleted filtrate. The column may comprise a hollow fiber. In exemplary embodiments, the filtrate may flow through the shell-side of the hollow fiber (outside), while the acid solution may flow countercurrent through the lumen-side of the hollow fiber (inside). The countercurrent acid may be sulfuric acid. In such embodiments, the ammonia stripped from the column may be in the form of ammonium sulfate. Any captured ammonium sulfate may be collected for the solids product.

In exemplary embodiments, the ammonia-reducing column may be a Liqui-Cel® membrane contactor (distributed by 3M, Saint Paul, MN).

The water recovery system may comprise a source of a pH adjuster positioned upstream from the ammonia-reducing column. The source of the pH adjuster may be an acid or a base. In one exemplary embodiment, the source of the pH adjuster may comprise sulfuric acid.

The water recovery subsystem may comprise a second solids-liquid separation subsystem having an inlet fluidly connected to the ammonia-depleted filtrate outlet, at least one retentate outlet, and at least one permeate outlet. The second solids-liquid separation subsystem may be configured to treat the ammonia-depleted filtrate to produce a concentrated retentate and an organic-depleted filtrate outlet.

The second solids-liquid separation subsystem may comprise a first nanofiltration unit having an inlet fluidly connected to the ammonia-depleted filtrate outlet, a retentate outlet, and an organic-depleted filtrate outlet. The nanofiltration unit may be a membrane filter, a hollow fiber membrane filter, a plate and frame membrane filter, a spiral membrane, a dead end filter, a cross-flow filter, or any other type of filter having pores dimensioned to perform nanofiltration. The average pore size of the nanofiltration membrane may be, for example, from 0.02 μm to 0.1 μm. The nanofiltration unit may be configured to separate the ammonia-depleted filtrate into an organic containing reject containing organic contaminants and divalent ions and an organic-depleted filtrate.

The water recovery subsystem may comprise a second source of a pH adjuster positioned upstream from the second solids-liquid separation subsystem, for example, positioned upstream from the nanofiltration unit. The second source of the pH adjuster may be an acid or a base. In one exemplary embodiment, the second source of the pH adjuster may comprise sulfuric acid. The system may additionally or alternatively comprise a source of an antiscalant positioned upstream from the second solids-liquid separation subsystem, for example, upstream from the nanofiltration unit.

The water recovery subsystem may comprise a first reverse osmosis unit having an inlet fluidly connected to the organic-depleted filtrate outlet, a retentate outlet, and a permeate outlet. A reverse osmosis unit may employ a partially permeable membrane to separate ions and other small molecules from a stream under pressure. The reverse osmosis unit may be a brackish water reverse osmosis unit. The brackish water reverse osmosis unit may operate under a pressure of about 200 psi. The reverse osmosis unit may be configured to concentrate the organic containing reject and produce a concentrated retentate comprising dissolved solids and a permeate.

The water recovery system may comprise a third source of a pH adjuster positioned upstream from the first reverse osmosis unit. The second source of the pH adjuster may be an acid or a base. In one exemplary embodiment, the second source of the pH adjuster may comprise sulfuric acid. The water recovery subsystem may additionally or alternatively comprise a second source of an antiscalant positioned upstream from the reverse osmosis unit. The water recovery subsystem may additionally or alternatively comprise a source of potassium bisulfite positioned upstream from the reverse osmosis unit.

The system may comprise a production water storage tank having an inlet fluidly connected to the permeate outlet of the first reverse osmosis unit. The production water storage tank may be configured to direct permeate to a clean in place liquid holding tank.

In some embodiments, the water recovery subsystem may comprise a second nanofiltration unit having an inlet fluidly connected to the retentate outlet of the first nanofiltration unit, a third retentate outlet, and a second organic-depleted filtrate outlet. The second nanofiltration unit may be configured to separate the organic containing reject to produce a second organic containing reject and a second organic depleted filtrate.

The water recovery subsystem may comprise a third source of an antiscalant positioned upstream from the second nanofiltration unit.

The water recovery subsystem may further comprise a second reverse osmosis unit having an inlet fluidly connected to the retentate outlet of the first reverse osmosis unit and the second organic-depleted filtrate outlet of the second nanofiltration unit, a fourth retentate outlet, and a second permeate outlet fluidly connected to the production water storage tank. The second reverse osmosis unit may be a seawater reverse osmosis unit. The seawater reverse osmosis unit may be configured to operate under a pressure of about 1,000 psi. The second reverse osmosis unit may be a brine recovery reverse osmosis unit. The second reverse osmosis unit may be configured to concentrate a dilute retentate (formed by the combination of the concentrated retentate and the second organic-depleted filtrate) and produce a second concentrated retentate comprising dissolved solids and a second permeate. The second permeate may be directed to the production water storage tank to be combined with the permeate from the first reverse osmosis unit.

The water recovery subsystem may comprise a fourth source of an antiscalant positioned upstream from the second reverse osmosis unit.

The system may comprise a solids product treatment subsystem. The solids product treatment subsystem may be positioned onsite, downstream from the solids product holding tank. The solids product treatment subsystem may be positioned at a remote location. The solids product treatment subsystem may be configured to process the solids product to produce a class A biosolids product. The solids product treatment subsystem may be configured to process the solids product to produce a fertilizer product. In some embodiments, the solids product treatment subsystem may comprise a drier. The solids product treatment subsystem may comprise a source of nutrients and/or fertilizer agent.

The system may comprise one or more clean in place water holding tanks. The clean in place water holding tank may be fluidly connected to the production water storage tank. The clean in place water holding tank may direct recovered water, for example, permeate, or cleaning fluid, for example, recovered water dosed with at least one cleaning agent, to backwash the at least one microfiltration unit, nanofiltration unit, or reverse osmosis unit of the system to perform a clean in place operation. The clean in place water storage tank may be fluidly connected to a source of a cleaning agent. The clean in place water storage tank may be configured to direct clean in place waste to the solids product holding tank.

The system may comprise one or more pumps or valves configured to direct fluid through the unit operations. The system may comprise one or more sensors, for example, composition sensors, configured to measure composition of one or more fluid. The system may comprise one or more pH sensors configured to measure pH of one or more fluid. In some embodiments, the system may comprise a digestate composition sensor. The sensor may be configured to measure one or more of TKN, NH₃—N, and PO₄—P of the digestate. In some embodiments, the system may comprise a biogas composition sensor. The sensor may be configured to measure methane content of the biogas. In some embodiments, the system may comprise a biogas flow volume sensor. In some embodiments, the system may comprise a wastewater composition sensor. The sensor may be configured to measure one or more of pH, total solids, BOD, and C:N of the wastewater.

The system may comprise a controller operably connected to the one or more sensor and configured to alert a user responsive to the sensor measuring a value outside tolerance of a predetermined range. The controller may be operably connectable to the one or more pumps or valves. For example, the controller may be configured to direct administration of a dosing agent responsive to a measured value, for example, a measured pH unit. In some embodiments, the controller may be operably connectable to the temperature control unit of the anaerobic digester. The controller may be operably connectable to the stirrer of the anaerobic digester.

In exemplary embodiments, the controller may be configured to dose the wastewater with nutrients and/or alkalinity agents responsive to the composition of the digestate, for example, TKN, NH₃—N, and/or PO₄—N concentration of the digestate. In some embodiments, the controller may be configured to modify mixing conditions of the anaerobic digester responsive to the methane content of the biogas or flow volume of the biogas.

The controller may be a computer or mobile device. The controller may comprise a touch pad or other operating interface. For example, the controller may be operated through a keyboard, touch screen, track pad, and/or mouse. The controller may be configured to run software on an operating system known to one of ordinary skill in the art. The controller may be electrically connected to a power source. The controller may be digitally connected to the one or more components. The controller may be connected to the one or more components through a wireless connection. For example, the controller may be connected through wireless local area networking (WLAN) or short-wavelength ultra-high frequency (UHF) radio waves. The controller may further be operably connected to any additional pump or valve within the system, for example, to enable the controller to direct fluids or additives as needed. The controller may be coupled to a memory storing device or cloud-based memory storage.

Multiple controllers may be programmed to work together to operate the system. For example, a controller may be programmed to work with an external computing device. In some embodiments, the controller and computing device may be integrated. In other embodiments, one or more of the processes disclosed herein may be manually or semi-automatically executed.

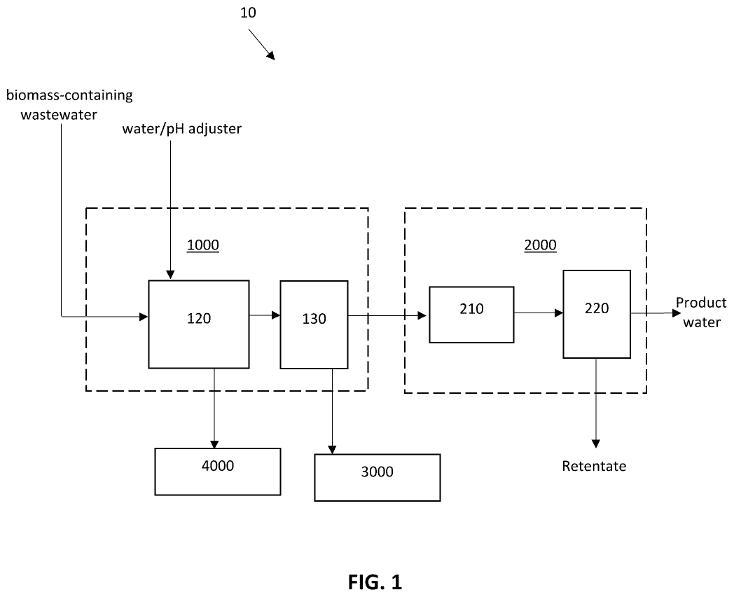

Referring to FIG. 1, a system 10 for treatment of biomass-containing wastewater is shown. The system 10 comprises an organic material digestion subsystem 1000 and a water recovery subsystem 2000. The organic material digestion subsystem 1000 comprises an anaerobic digester 120 and a solids-liquid separation subsystem 130. The anaerobic digester 120 may be a BVF® reactor from Evoqua Water Technologies, LLC. The water recovery subsystem 2000 comprises an ammonia-reducing column 210 and a second solids-liquid separation subsystem 220. The organic material digestion subsystem 1000 has a solids outlet fluidly connected to solids product subsystem 3000 comprising a holding tank. The solids product subsystem 3000 may comprise a solids product treating subsystem. Biogas produced by the anaerobic digester 120 is directed to a biogas processing subsystem 4000. The biogas processing subsystem 4000 may comprise an energy harvesting unit and/or a biogas treatment unit. The water recovery subsystem 2000 has a product water outlet configured to direct recovered water to a point of use. The water recovery subsystem 2000 has a retentate outlet to direct retentate to a retentate disposal system, for example, a sewer. The system 10 may be operated to recover water from the digestion process and produce minimal liquid waste.

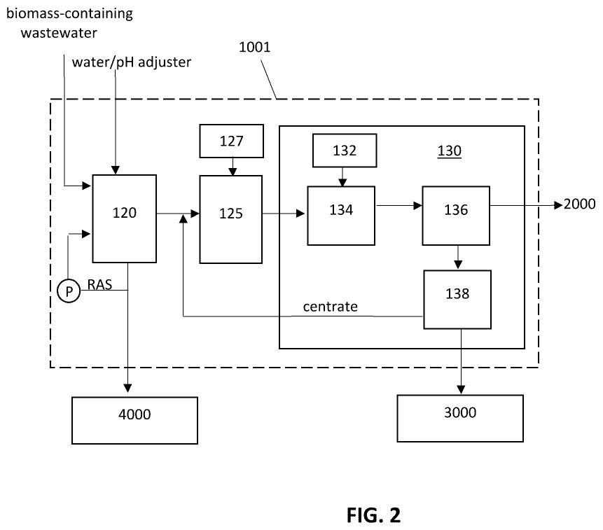

Referring to FIG. 2, an exemplary biomass digestion subsystem 1001 is shown. The biomass digestion subsystem 1001 includes anaerobic digester 120, oxidation tank 125, and solids-liquid separation subsystem 130. A portion of the sludge produced in the anaerobic digester 120 may be returned to the anaerobic digester as return activated sludge (RAS) via a pump P. The anaerobic digester 120 may be supplied with water and/or a pH adjustment agent to keep the pH in the anaerobic digester at a level conducive to anaerobic digestion of the biomass in the wastewater.

The oxidation tank 125 receives digestate from the anaerobic digester 120 and is supplied with an oxygen-containing gas, for example, air from a source of the gas 127. The oxidation tank 125 may be used to oxidize any dissolved sulfides in the digestate from the anaerobic digester 120.

The solids-liquid separation subsystem 130 includes source of a separation additive 132, a reaction tank 134 for mixing the separation additive 132 with effluent from the oxidation tank 125, a concentration tank 136, and a solids/liquid separation apparatus 138, for example, a centrifuge. The separation additive may be a softening agent, coagulant, and/or a flocculant. The separation additive may comprise, for example, calcium hydroxide (lime), ferric sulfate, an anionic polymer, and/or a cationic polymer.

The concentration tank 136 may be used to mix the digestate from the anaerobic digester 120 with the separation additive to form a mixed liquid. A portion of the mixed liquid may be directed into the centrifuge 138. The remainder of the mixed liquid from the concentration tank 136 is provided to the water recovery subsystem 2000.

Solids from the centrifuge 132 are directed to the solids product subsystem 3000. Separated liquids or centrate may be returned from the centrifuge 138 to the oxidation tank 125. Biogas from the anaerobic digester 120 is directed to the biogas processing subsystem 4000.

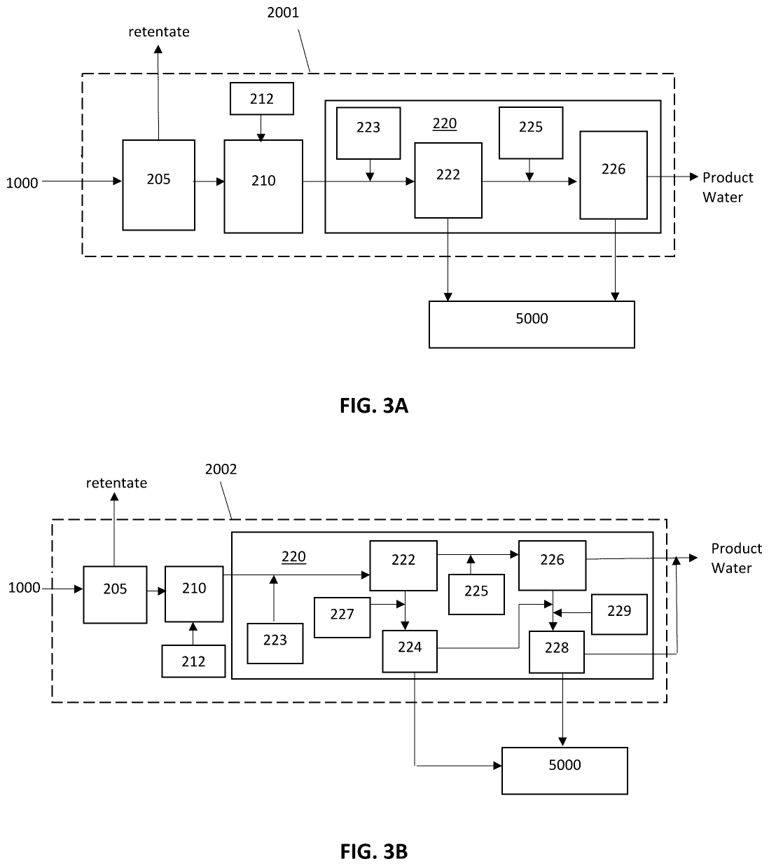

Referring to FIG. 3A, an exemplary water recovery subsystem 2001 is shown. Water recovery subsystem 2001 includes a filtration module 205, for example, a cross-flow filtration unit such as the MemTek® cross-flow microfiltration system from Evoqua Water Technologies LLC, ammonia reducing column 210, and solids-liquid separation subsystem 220. Retentate from the filtration module 205 may be removed and used as, for example, make-up water for a biogas scrubber used to scrub the biogas produced in the anaerobic digester 120. The ammonia reducing column 210 may be supplied with sulfuric acid from a source of sulfuric acid 212 to react with ammonia in the liquid stream to precipitate ammonium sulfate.

Solids-liquid separation subsystem 220 includes a first source of a dosing agent 223, nanofiltration unit 222, a second source of a dosing agent 225, and reverse osmosis unit 226. The dosing agent may comprise, for example, a pH adjuster, an antiscalant, and/or potassium bisulfite. Reverse osmosis unit 226 includes a permeate/product water outlet. Nanofiltration unit 222 and reverse osmosis unit 226 have retentate outlets directed to retentate disposal subsystem 5000, for example, a sewer or evaporation pond.

Referring to FIG. 3B, an alternate exemplary water recovery subsystem 2002 is shown. Water recovery subsystem 2002 is similar to water recovery subsystem 2001, except that the solids-liquid separation subsystem 220 includes third source of a dosing agent 227 and second nanofiltration unit 224 positioned downstream from the retentate outlet of the first nanofiltration unit 222. Second nanofiltration unit 224 may be a loose pore NF membrane unit designed for the removal of organic compounds for performing an NFRR process. Solids-liquid separation subsystem 220 also includes a fourth source of a dosing agent 229 and second reverse osmosis unit 228 positioned downstream from the retentate outlet of the first reverse osmosis unit 226. The first reverse osmosis unit 226 may be a BWRO unit and the second reverse osmosis unit 228 may be a SWRO unit, both of which may be used to remove inorganic ionic species for the water being treated. Second nanofiltration unit 224 has a filtrate outlet directed to second reverse osmosis unit 228. Second reverse osmosis unit 228 has a permeate outlet to send permeate to mix with the permeate from the first reverse osmosis unit 226 as product water. Second nanofiltration unit 224 and second reverse osmosis unit 228 have retentate outlets directed to retentate disposal subsystem 5000.

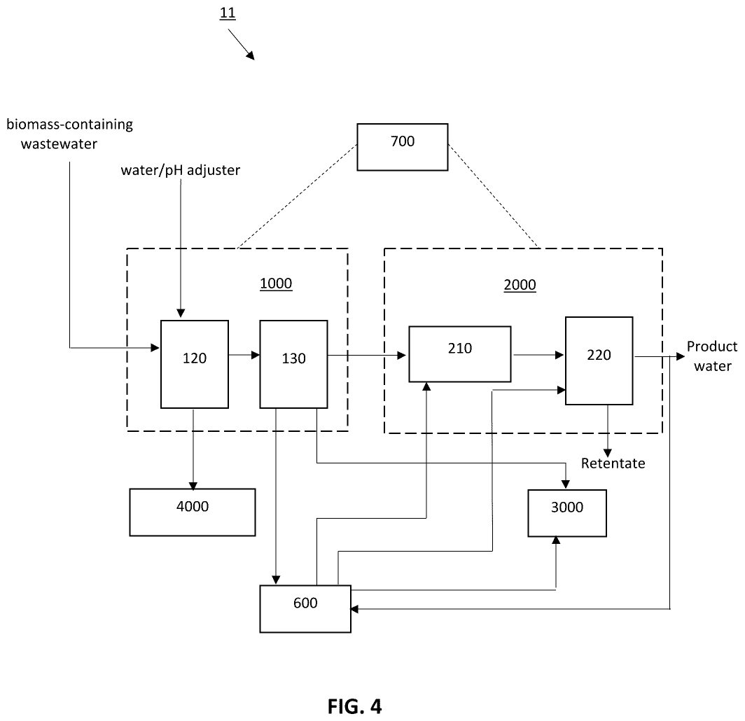

Referring to FIG. 4, system 11 for treatment of biomass-containing wastewater is shown. System 11 is similar to system 10 except that it includes clean in place tank 600 fluidly connected downstream from the product water outlet. Clean in place tank 600 is configured to direct cleaning fluid to solids-liquid separation subsystem 130 (for example, to clean a cross-flow filtration unit) and to solids-liquid separation subsystem 220 (for example, to provide make-up water to an ammonia reducing column, or provide cleaning fluid a nanofiltration unit or reverse osmosis unit). Clean in place tank 600 is configured to direct clean in place waste to a solids waste holding tank for disposal, for example, to solids product subsystem 3000. System 11 also includes controller 700. Controller 700 may be operatively connected to one or more pump, valve, or sensor of the system and configured to direct fluid (for example, administer a separation additive or dosing agent) or control temperature within the system (for example, with a temperature control unit of the anaerobic digester).

### EXAMPLES

The function and advantages of these and other embodiments can be better understood from the following examples. These examples are intended to be illustrative in nature and are not considered to be limiting the scope of the invention.

### Example 1: Mass Balance of a System for Treatment of Biomass-Containing Wastewater

A plant for treatment of biomass-containing wastewater has been designed based on pilot plant data. The plant will process approximately 1157 gpm of biomass-containing wastewater. The plant has an organic material digestion subsystem 1001 as illustrated in FIG. 2 upstream of a water recovery sub-system as illustrated in FIG. 3B.

After initial screening through a ¼ inch mesh basket strainer, the influent wastewater is directed into the anaerobic digester. The anaerobic digester produces 5.73 million ft³/day of biogas and 59 gpm of sludge with 3-4% TSS.

Anaerobically digested effluent from the anaerobic digester is mixed with 209 gpm of centrate from a downstream centrifuge and is treated in the oxidation tank for oxidation of sulfides. 1307 gpm of the wastewater being treated exits the oxidation tank and is dosed with lime and polymer coagulant. Solids from the wastewater being treated is allowed to settle in the concentration tank from which 240 gpm of sludge with a TSS of 4% is withdrawn, dosed with additional polymer, and sent to the centrifuge. The centrifuge separates the sludge from the concentration tank into 34 gpm of 25% solids which are disposed of and 209 gpm of centrate that is returned to the oxidation tank.

Mixed fluid from the concentration tank is directed into the cross-flow filtration system which separates the mixed fluid into 20 gpm retentate and 1067 gpm filtrate. The filtrate is treated in the ammonia stripping column which outputs 18.2 gpm of 20-25% ammonium sulfate solution. 1067 gpm of ammonia-stripped wastewater is directed into the first NF unit after being dosed with antiscalant and sulfuric acid. 800 gpm of filtrate from the first NF unit is directed into the first RO unit after being dosed with additional antiscalant and sulfuric acid. 267 gpm of retentate are directed into the second NF unit from the first NF unit after addition of additional antiscalant. 200 gpm of filtrate from the second NF unit and 96 gpm of retentate from the first RO unit are directed into the second RO unit. The first RO unit produces 704 gpm of permeate and the second RO unit produces 252 gpm of permeate which are mixed to form product water. 67 gpm of retentate from the second NF unit and 44 gpm of retentate from the second RO unit are sent out of the system for disposal.

Accordingly, the process produces 956 gpm of clean product water from 1152 gpm influent wastewater and generates 34 gpm of sludge and 111 gpm of retentate for disposal.

### Example 2: Digestion of Biomass

A sample of wastewater containing ethanol production stillage was treated in a system as disclosed herein. A number of parameters of the wastewater and the wastewater after treatment in the different unit operations of the system are presented in Table 1 below.

As illustrated, the system was able to reduce the TSS of the wastewater from 4,266 mg/L to undetectable levels in the final product water (RO permeate) and the VSS of the wastewater from 3,839 mg/L to undetectable levels in the final product water. The TDS of the wastewater was reduced from 4,769 mg/L to 330 mg/L in the final product water. Sodium, calcium, sulfate, carbonate, and ammonia all exhibited greatly reduced levels after treatment. 6.39 Scfd/lb COD of biogas was produced.

TABLE 1
Wastewater parameters at different stages of treatment

| Parameter | Units | Stillage | BVF Effluent | NF/RO Reject | RO Permeate |
|---|---|---|---|---|---|
| Temperature | ° F. | | 90 to 98 | | |
| pH | SU | TBD | 6.5-7.5 | 6-8 | |
| Total Suspended | mg/L | 4,266 | 2,500 | <5 | <1 |
| Solids (TSS) | | | | | |
| Volatile Suspended | mg/L | 3,839 | | <5 | <1 |
| Solids (VSS) | | | | | |
| Alkalinity as CaCO₃ | mg/L | TBD | | | |
| TN | mg/L | 1,391 | 1,110 | 470 | |
| NH₄—N | mg/L as | 231 | | 450 | 1.1 |
| | N | | | | |
| Nitrate-N | mg/L as | TBD | | | |
| | N | | | | |
| Carbonate | mg/L | 30.8 | | | 0.034 |
| Bicarbonate | mg/L | 5,258 | | | |
| Chloride | mg/L | 174 | 174 | 9200 | |
| Fluoride | mg/L | TBD | | | |
| Silica (SiO₂) | mg/L | 25 | 25 | | |
| PO₄—P | mg/L as P | 190 | 156 | 190 | |
| SO₄—S | mg/L as S | 361 | | 747 | 0.23 |
| dH₂S + HS⁻ | mg/L as S | TBD | | | 25 |
| Biochemical Oxygen | mg/L | 36,000 | 2,000 | 2200 | |
| Demand (BOD) | | | | | |
| Soluble Chemical | mg/L | 55,510 | | | |
| Oxygen Demand | | | | | |
| (sCOD) | | | | | |
| Total Chemical Oxygen | mg/L | 60,203 | 6,000 | | |
| Demand (COD) | | | | | |
| Total Organic Carbon | mg/L | TBD | | 6600 | |
| (TOC) | | | | | |
| Mg | mg/L | 240 | 240 | 48 | |
| Ca | mg/L | 142 | 100 | 95 | 0.75 |
| K | mg/L | 863 | 863 | 7865 | |
| Na | mg/L | 1,549 | 1,549 | 14140 | 50 |
| Iron | mg/L | TBD | | | |
| Manganese | mg/L | TBD | | | |
| Aluminum | mg/L | TBD | | | |
| Total Dissolved Solids | mg/L | 4,769 | 4,769 | 26685 | 330 |
| (TDS) | | | | | |

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A method of treating biomass and ammonia-containing wastewater, the method comprising:
anaerobically digesting the biomass and ammonia-containing wastewater to produce a biogas and a digestate;
oxidizing dissolved sulfides in the digestate;
mixing the digestate to form a mixed liquid;
filtering a portion of the mixed liquid to produce a first filtrate and a first retentate;
removing ammonia from the first filtrate to produce an ammonia-depleted filtrate;
removing organic contaminants and divalent ions from the ammonia-depleted filtrate by nanofiltration to produce an organic-containing second retentate comprising divalent ions and an organic-depleted second filtrate;
removing additional organic contaminants from the organic-containing second retentate by a second nanofiltration operation to produce a third filtrate and a third retentate;
removing inorganic ionic species from the organic-depleted second filtrate by reverse osmosis to produce a fourth filtrate and a fourth retentate;
combining the third filtrate and the fourth retentate; and
removing additional inorganic ionic species from the combined third filtrate and fourth retentate by a second reverse osmosis operation to form a product water.

2. The method of claim 1, further comprising performing solids-liquid separation of a second portion of the mixed liquid and returning the liquid obtained to a vessel for oxidizing the dissolved sulfides.

3. The method of claim 1, further comprising controlling pH of the ammonia-depleted filtrate to be between about 7-9 and dosing the ammonia-depleted filtrate with an antiscalant.

4. The method of claim 1, further comprising processing the biogas to produce natural gas.

5. The method of claim 4, further comprising using energy generated by the biogas to power at least one operation of the method.

6. The method of claim 1, further comprising adjusting a pH of the biomass and ammonia-containing wastewater to about 6 or above prior to anaerobically digesting the biomass and ammonia-containing wastewater.

7. A system for treating biomass and ammonia-containing wastewater, the system comprising:
an anaerobic digester having an inlet fluidly connectable to a source of the biomass-containing wastewater, a biogas outlet, and a digestate outlet;
an oxidation tank having an inlet fluidly connected to the digestate outlet, and an oxidation tank outlet;
a source of softening agent configured to deliver the softening agent into a mixing vessel having an inlet fluidly connected to the oxidation tank outlet, and a mixing vessel outlet;
a concentration tank having an inlet fluidly connected to the mixing vessel outlet, and first and second mixed liquid outlets;
a solids-liquid separator having an inlet fluidly connected to the first mixed liquid outlet of the concentration tank, and a separated liquids outlet fluidly connected to the inlet of the oxidation tank;
a membrane filtration unit having an inlet fluidly connected to the second mixed liquid outlet of the concentration tank, a filtrate outlet, and a retentate outlet;
an ammonia-reducing column having an inlet fluidly connected to the filtrate outlet, a countercurrent source of an acid, and an ammonia-depleted filtrate outlet;
a first nanofiltration unit having an inlet fluidly connected to the ammonia-depleted filtrate outlet, a filtrate outlet, and a retentate outlet;
a second nanofiltration unit having an inlet fluidly connected to the retentate outlet of the first nanofiltration unit, and a filtrate outlet;
a first reverse osmosis unit having an inlet fluidly connected to the filtrate outlet of the first nanofiltration unit, a filtrate outlet, and a retentate outlet; and
a second reverse osmosis unit having an inlet fluidly connected to the filtrate outlet of the second nanofiltration unit and the retentate outlet of the first reverse osmosis unit.

8. The system of claim 7, wherein the solids-liquid separator comprises a centrifuge.

9. The system of claim 8, further comprising at least one of a source of a coagulant and a source of a flocculant positioned upstream from the centrifuge.

10. The system of claim 7, further comprising a first source of a pH adjuster positioned upstream from the ammonia-reducing column.

11. The system of claim 10, further comprising a second source of a pH adjuster positioned upstream from the first nanofiltration unit and/or a source of an antiscalant positioned upstream from the first nanofiltration unit.

12. The system of claim 7, wherein the anaerobic digester is a continuous stirred tank reactor (CSTR).
